(19) United States
(12) Patent Application Publication
(10) Pub. No.: US 2026/0265569 A1
(43) Pub. Date: Sep. 10, 2026

(54) COATING COMPOSITION FOR IMPROVED CHALKING

(71) Applicant: Arkema Inc., King of Prussia, PA (US)

(72) Inventors: Kelly E. LUTZ, King of Prussia, PA (US); Abby MILLER, King of Prussia, PA (US)

(21) Appl. No.: 19/168,427

(22) PCT Filed: Mar. 22, 2024
(86) PCT No.: PCT/US2024/021087

§ 371 Date: Sep. 24, 2025

Related U.S. Application Data
(60) Provisional application No. 63/454,792, filed on Mar. 27, 2023.

(51) Int. Cl. C09D 127/16; C08K 3/22; C09D 7/20; C09D 7/61; C09D 7/65

(52) U.S. Cl. CPC C09D 127/16; C08K 3/22; C09D 7/20; C09D 7/61; C09D 7/65; C08K 2003/2241

(57) ABSTRACT

A coating composition comprising a blend of AMF polymer and acrylic polymer binder show improved chalking, compared to a coating composition with only acrylic polymer binder.

### FIELD OF THE INVENTION

The invention relates to coating composition having improved chalking.

### BACKGROUND OF THE INVENTION

Fluoropolymer coatings, particularly those based on polyvinylidene fluoride (PVDF) resins, have a long history of outstanding performance in outdoor coating applications. However, the chemical inertness of PVDF presents challenges to the paint formulator in that it prevents adhesion to substrates and makes it difficult to disperse pigments. To overcome these difficulties, an acrylic modifier resin is usually added to the PVDF resin. The acrylic modifier is traditionally physically blended with the PVDF resin to improve coating adhesion and enhance pigment dispersion. The physical blending results in a PVDF/acrylic mixture on a macro-molecular scale. More recently acrylic modified fluoropolymers were introduced. Acrylic modified fluoropolymers (“AMF polymer”) mix the fluoropolymer and acrylic on micro-molecular scale namely acrylic monomers are polymerized in the presence of a fluoropolymer seed resulting in an AMF polymer. This may be referred to as an interpenetrating network (“IPN”). AMF polymers having PVDF as the fluoropolymer seed may be referred to as PVDF-acrylic hybrid polymers or dispersions. These AMF polymers exhibit properties that a simple blend of a fluoropolymer and an acrylic polymer do not. Such AMF polymers are available from Arkema Inc. under the Tradename Kynar Aquatec®.

These AMF polymers have been used as the neat polymer binder in coating formulations. Due to the high wt % of fluoropolymer in these AMF polymers, either organic solvents or coalescing agent are added to the composition to aid the discrete particles of polymer that are present in the latex to form into a continuous film.

There is a need for a coating that exhibits less VOC but still exhibits good chalking, dirt pickup resistance (DPUR) and color retention.

Applicant have found that by combining aqueous AMF polymer with acrylic polymer binder, where the total fluoropolymer is from 8 to 25 wt percent of the total polymer in a coating composition, less coalescing agent can be used yet the desired characteristic such as chalking are retained.

### BRIEF SUMMARY OF INVENTION

A coating composition comprising a blend of acrylic polymer binder and AMF polymer as the binders show improved chalking, color retention, and dirt pickup resistance compared to the same coating composition except substituting the acrylic polymer binder in the composition tested for the AMF polymer.

Disclosed is an aqueous coating composition comprising:
a. 8-25 wt % PVDF polymer based on total polymer in the composition,
b. acrylic polymer (includes both the acrylic polymer binder and the acrylic polymer portion of the AMF polymer)
c. an opacifying pigment and
d. coalescing agent.
   Optionally the aqueous coating composition comprises at least one colored pigment. Preferably the coalescing agent is used in an amount of less than 3.9 wt % based on total acrylic plus PVDF solids.

### Aspects of the Invention

A First aspect of the invention is an aqueous coating composition comprising:
from 8-25% PVDF polymer based on total weight of polymer (acrylic polymer binder plus AMF polymer) in the composition,
acrylic polymer (includes both the acrylic polymer binder and the acrylic polymer portion of the AMF polymer),
an opacifying pigment,
water,
and less than 3.9 wt % amount of coalescing agent based on total wet composition,
wherein the PVDF is in the form of an AMF polymer.

Second aspect of the invention: The aqueous coating composition of aspect 1, wherein the PVDF in the composition is from 10 to 25 wt % based on total polymer solids in the composition.

Third aspect of the invention: The aqueous coating composition of aspect 1, wherein the PVDF in the composition is from 10 to 20 wt % based on total polymer solids in the composition.

Forth aspect of the invention: The aqueous coating composition of any one of aspects 1 to 3, wherein the AMF polymer comprises from 30 wt % to 70 wt % PVDF and from 70 wt % to 30 wt % acrylic polymer portion.

Fifth aspect of the invention: The aqueous coating composition of any one of aspects 1 to 3, wherein the AMF polymer comprises from 40 wt % to 85 wt % PVDF and from 60 wt % to 15 wt % acrylic polymer portion based on total wt of AMF polymer.

Sixth aspect of the invention: The aqueous coating composition of any one or more of aspects 1 to 5, wherein the acrylic polymer portion of the AMF polymer comprises (methyl) methacrylate monomer units.

Seventh aspect of the invention: The aqueous coating composition of any one or more of aspects 1 to 6, wherein the total acrylic polymer (meaning acrylic polymer binder plus the acrylic portion of the AMF polymer) in the composition is from 75 to 92 wt % based on total polymer in the composition.

Eighth aspect of the invention: The aqueous coating composition of any one or more of aspects 1 to 7, further comprising at least one colored pigment.

Ninth aspect of the invention: The aqueous coating composition of any one or more of aspects 1 to 8, wherein the coalescing agent is less 3 wt % based on total wet composition.

Tenth aspect of the invention: The aqueous coating composition of any one or more of aspects 1 to 8, wherein the coalescing agent is less 2.5 wt % based on total wet composition, preferably less than 2% or less of the total weight of the coating composition (including water).

Eleventh aspect of the invention: The aqueous coating composition of any one or more of aspects 1 to 8, wherein the coalescing agent is less 1.7 wt % based on total wet composition.

Twelfth aspect of the invention: A method of coating a substrate comprising provide a substrate, providing the coating composition of any one of the preceding aspects, applying the coating composition to the substrate, drying the coating composition on the substrate to form a coating.

Thirteenth aspect of the invention: A coating comprising any one of the coating compositions of any one or more of aspects 1 to 11 wherein the coating exhibits an improved chalking (ASTM 4214-07) compared to the same coating composition without the AMF polymer.

Fourteenth aspect of the invention: The coating of aspect 19 wherein the chalking value of at least 4 is obtained.

Fifteenth aspect of the invention: The coated of aspect 13 or 14, and wherein the coating exhibits an improved dirt pickup resistance over a coating that does not contain the AMF polymer.

Sixteenth aspect of the invention: The coated of any one or more of aspects 13-15, and wherein the colored pigment has after 4000 hours of QUV-B weathering has improved color retention over a coating that does not contain the AMF polymer.

Seventeenth aspect of the invention: The coated of aspect 16 where in the improvement of color retention is at least 10% less, preferably 20% less as measure by change in Delta E* (ΔE) over 4000 hours QUV-B weathering over the same coating made except without the AMF polymer (substituting the acrylic polymer binder in the formulation tested for the AMF polymer).

### DESCRIPTION OF THE INVENTION

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

All references listed in this application are incorporated herein by reference. All percentages in a composition are wt %, unless otherwise indicated.

Unless otherwise stated, molecular weight is a weight average molecular weight as measured by GPC, using a polymethyl methacrylate standard. In cases where the polymer contains some cross-linking, and GPC cannot be applied due to an insoluble polymer fraction, soluble fraction/gel fraction or soluble faction molecular weight after extraction from gel is used. Crystallinity and melting temperature are measured by DSC as described in ASTM D3418 at heating rate of 10 C/min. Melt viscosity is measured in accordance with ASTM D3835 at 230° C. expressed in k Poise @100 sec⁻¹.

The term “polymer” is used to mean both homopolymers, copolymers and terpolymers (three or more monomer units), unless otherwise stated. “Copolymer” is used to mean a polymer having two or more different monomer units.

The term “PVDF” and “polyvinylidene fluoride” is used to connote both the homopolymer and copolymers, unless specifically noted otherwise. The polymers may be homogeneous, heterogeneous, and may have a gradient distribution of co-monomer units. For purposes of this invention, the term PVDF does not include the acrylic polymer portion of the AMF polymer. The term PVDF or PVDF resin only includes PVDF used as the fluoropolymer seed polymer portion of the AMF polymer.

Acrylic modified fluoropolymer (“AMF polymer”), sometimes referred to as Fluoropolymer-acrylic hybrid dispersion means a composition in which acrylic monomer has been polymerized in the presence of a fluoropolymer seed. Such AMF polymers are described in US patents U.S. Pat. Nos. 5,349,003, 6,680,357 and US 2011/0118403, all which is hereby incorporated by reference.

“Acrylic” encompasses both acrylic and meth acrylic monomers unless otherwise specified. Acrylic polymer encompasses polymers have at least one of acrylic monomer and/or meth acrylic monomers.

The invention provides for a composition comprising an AMF polymer wherein the fluoropolymer portion of the AMF polymer comprises 8-25 wt % based on total polymer weight in the composition. The composition further comprises acrylic polymer binder, an opacifying pigment, and less than 3.9 wt % amount of coalescing agent based total acrylic polymer binder plus AMF polymer. The composition optionally comprises at least one colored pigment. The fluoropolymer of the invention must be in the form of an AMF polymer. The use of the AMF polymer in conjunction with an acrylic polymer binder provides for the benefit of the invention.

The invention provides for a coating comprising the composition of the invention. The dried coating may exhibit improved chalking over the same coating made except without the AMF polymer (substituting the same acrylic polymer binder in the formulation tested for the AMF polymer). The chalking value may be at least 2 units improved over the same composition without the AMF polymer.

The invention may provide for improved color retention of at least 10% less, preferably 20% less as measure by change in Delta E* over 4000 hours QUV-B weathering over the same coating made except without the AMF polymer (substituting the same acrylic polymer binder in the formulation tested for the AMF polymer).

The present invention may provide for lowered VOC emissions and longer lifetime of coatings because less solvent is used and the final coating exhibits a longer life requiring less maintenance.

### Fluoropolymer Portion of the AMF Polymer

The fluoropolymers used in the invention as seed for the acrylic polymerization step resulting in the AMF polymer, are formed primarily of fluoromonomers. The term “fluoromonomer” or the expression “fluorinated monomer” means a polymerizable alkene which contains at least one fluorine atom, fluoroalkyl group, or fluoroalkoxy group attached to the double bond of the alkene that undergoes polymerization. The term “fluoropolymer” means a polymer formed by the polymerization of at least one fluoromonomer, and it is inclusive of homopolymers, copolymers, terpolymers The fluoropolymer preferably contains at least 50 mole percent of one or more fluoromonomers.

Fluoromonomers useful in the practice of the invention include, for example, vinylidenefluoride (VDF), tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole, and combinations thereof.

The fluoropolymer used as seed particles is preferably a vinylidene fluoride polymer obtained by emulsion-polymerization. Such an aqueous vinylidene fluoride polymer can be produced by a conventional emulsion polymerization method, for example, by emulsion-polymerizing the starting monomers in an aqueous medium in the presence of a polymerization initiator, this process is known in the art. Specific examples of the vinylidene fluoride polymer obtained by emulsion-polymerization include vinylidene fluoride homopolymer and copolymers of (1) vinylidene fluoride and (2) a fluorine-containing ethylenically unsaturated compound (e.g. tetrafluoroethylene (TFE), trifluoroethylene (VF3), chlorotrifluoroethylene (CTFE), hexafluoropropene (HFP), vinyl fluoride (VF), hexafluoroisobutylene, perfluorobutylethylene (PFBE), pentafluoropropene, 2,3,3,3-tetrafluoropropene (HFO-1234yf), 2-chloro-1-1-difluoroethylene (R-1122), 3,3,3-trifluoro-1-propene, 2-fluoromethyl-3,3,3-trifluoropropene, a fluorinated vinyl ether, a fluorinated allyl ether, a non-fluorinated allyl ether, a fluorinated dioxole, perfluoroacrylic acid or the like), a fluorine-free ethylenically unsaturated compounds (e.g. cyclohexyl vinyl ether, hydroxyethyl vinyl ether or the like), a fluorine-free diene compound (e.g. butadiene, isoprene, chloroprene or the like) or the like, all of them being copolymerizable with vinylidene fluoride. Of these, preferred are vinylidene fluoride homopolymer, vinylidene fluoride/tetrafluoroethylene copolymer, vinylidene fluoride/hexafluoropropylene copolymer, vinylidene fluoride/tetrafluoroethylene/hexafluoropropylene copolymer, etc.

Especially preferred fluoropolymers are homopolymers of VDF, and copolymers of VDF with HFP, TFE or CTFE, comprising from about 50 to about 99 wt % VDF, more preferably from about 70 to about 99 wt % VDF. Especially preferred copolymers are copolymers of VDF and HFP where the wt % of VDF in the copolymer is from 50 to 99 wt %, preferably from 65 to 95 wt % based on total monomers in the copolymer. In one preferred embodiment of a VDF/HFP copolymer, the wt % of HFP is from 5 to 30 wt %, preferably from 8 to 25 wt % based on the total monomer in the polymer.

The fluoropolymer preferably has a high molecular weight. By high molecular weight, as used herein, is meant PVDF having a melt viscosity of greater than 1.0 kilopoise, preferably greater than 5 kilopoise, more preferably greater than 10 kilopoise, according to ASTM method D-3835 measured at 230° C. and 100 sec-1.

Preferably, the fluoropolymer is formed by an emulsion process. Preferably, the process is fluoro-surfactant free. The fluoropolymer used in the invention is free of fluorosurfactant.

### Acrylic Portion of the AMF Polymer

The AMF polymer contains an acrylic portion (“acrylic polymer portion”). The acrylic polymer portion of the AMF polymer is obtained by emulsion-polymerizing 5-95 parts by weight (per 100 parts by weight of vinylidene fluoride polymer) of a monomer mixture comprising at least one monomer selected from the group consisting of alkyl acrylates whose alkyl groups have 1-18 carbon atoms and alkyl methacrylates whose alkyl groups have 1-18 carbon atoms and an ethylenically unsaturated compound copolymerizable with the alkyl acrylates and the alkyl methacrylates, in an aqueous medium in the presence of 100 parts by weight of particles of a vinylidene fluoride polymer.

The alkyl acrylate with an alkyl group having 1-18 carbon atoms, used as one monomer to be emulsion-polymerized in the presence of the vinylidene fluoride polymer particles, includes, for example, methyl acrylate, ethyl acrylate, propyl acrylate, n-butyl acrylate, isobutyl acrylate, amyl acrylate, isoamyl acrylate, hexyl acrylate, 2-ethylhexyl acrylate, diacetone acrylamide, lauryl acrylate and the like. Of these, alkyl acrylates with an alkyl group having 1-8 carbon atoms are preferred, and alkyl acrylates with an alkyl group having 1-5 carbon atoms are more preferable. The alkyl methacrylate with an alkyl group having 1-18 carbon atoms, used as the other monomer to be emulsion-polymerized, includes, for example, methyl methacrylate, ethyl methacrylate, propyl methacrylate, n-butyl methacrylate, isobutyl methacrylate, amyl methacrylate, isoamyl methacrylate, hexyl methacrylate, lauryl methacrylate and the like. Of these, alkyl methacrylates with an alkyl group having 1-8 carbon atoms are preferred, and alkyl methacrylates with an alkyl group having 1-5 carbon atoms are more preferable. These compounds (alkyl acrylate and alkyl methacrylate) may be used alone or in admixture of two or more.

When both the alkyl acrylate and the alkyl methacrylate are used, the proportions of these two esters are not critical and can be appropriately varied depending upon the desired properties of the resulting fluorine-containing polymer.

Preferably, the acrylic polymer portion in the AMF polymer comprises (methy)methacrylate monomer units and preferably may contain greater than 50 wt % (methy)methacrylate monomer units based on the total monomer in the acrylic polymer portion of the AMF polymer.

The average particle size of the AMF polymer in the latex resulting from the polymerization process (“AMF polymer latex”) is 0.05-3 μm, preferably 0.05-1 μm, more preferably 0.1-1 μm particle size is measured by dynamic light scattering using a NICOMP™ 380 submicron particle sizer. The data is reported as intensity average particle size (diameter).

The AMF polymer latex may optionally include 0 to 15 wt % based on the polymer, and preferably 0.1 to 10 wt % of additives, including but not limited to thickeners, pH adjusting agents, anti-settling agents, surfactants, wetting agents, fillers, anti-foaming agents, and fugitive adhesion promoters.

### Acrylic Polymer Binder (Non-Fluorinated)

Acrylic polymer binders are known in the art. Non-limiting examples of suitable ethylenically unsaturated (vinyl) monomers that can polymerized into a film-forming acrylic polymer binder can include acrylic monomers, and methacrylic monomers. As can be appreciated, a combination of more than one non-fluorinated acrylic polymer binder (“acrylic polymer binder”) can also be used. The acrylic polymer binders of the present invention are not fluorinated.

In some embodiments the acrylic polymer binder can be an aqueous emulsion polymerization product of an ethylenically unsaturated (meth)acrylic monomer. For example, the ethylenically unsaturated (meth)acrylic monomer can be selected from the group consisting of acrylic and methacrylic acids; alkyl acrylates and methacrylates, and hydroxyl-substituted derivatives; acrylonitrile; glycidyl acrylates and methacrylates, and combinations thereof. More specific examples including ethyl acrylate, methyl acrylate, butyl acrylate, propyl acrylate, isobutyl acrylate, amyl acrylate, 2-ethylhexyl acrylate, hexyl acrylate, ethyl methacrylate, methyl methacrylate, butyl methacrylate, propyl methacrylate, isobutyl methacrylate, amyl methacrylate, 2-ethylhexyl methacrylate, and hexyl meth acrylate

In addition, up to about 10 wt %, preferably less than 5 wt % of the (meth)acrylic monomer in the acrylic polymer binder may be substituted with one or more ethylenically unsaturated comonomers. Exemplary ethylenically unsaturated comonomers can include, among others, styrene and its derivatives, vinyl esters including vinyl acetate, vinyl isopropyl acetate, vinyl propionate, vinyl butyrate, vinyl pivalate, vinyl neo-nonanoate, 2-ethyl hexanoate, vinyl neo-decanoate, vinyl neoendecanoate, vinyl neo-dodecanoate, and mixtures thereof.

In addition, the acrylic polymer binder can comprise, in polymerized form, at least one ethylenically unsaturated (meth)acrylic monomer and about 0.01 to about 10 wt %, based on total weight of the acrylic polymer binder, of acetoacetate moiety containing monomer.

In some embodiments, the acrylic polymer binder may also include, in polymerized form, at least one wet adhesion monomer. The wet adhesion monomer can be present in an amount of from about 0.01 to about 10 wt % preferably about 0.05 to about 2 wt %, based on the total weight of the acrylic polymer binder.

Wet adhesion monomers can include, but are not limited to, aminoethyl acrylate and methacrylate, dimethylaminopropyl acrylate and methacrylate, 3-dimethylamino-2,2-dimethylpropyl-1-acrylate and methacrylate, 2-N-morpholinoethyl acrylate and methacrylate, 2-N-piperidinoethyl acrylate and methacrylate, N-(3-dimethylaminopropyl) acrylamide and methacrylamide, N(3-dimethylamino-2,2-dimethylpropyl) acrylamide and methacrylamide, N-dimethylaminomethyl acrylamide and methacrylamide, N-dimethylaminomethyl acrylamide and methacrylamide, N-(4-morpholino-methyl) acrylamide and methacrylamide, vinylimidazole, vinylpyrrolidone, N-(2-methacrloyloxyethyl) ethylene urea, N-(2-methacryloxyacetamidoethyl)-N,N′-ethyleneurea, allylalkyl ethylene urea, N-methacrylamidomethyl urea, N-methacryoyl urea, N-[3-(1,3-diazacryclohexan)-2-on-propy]methacrylamide, 2-(1-imidazolyl)ethyl methacrylate, 2-(1-imidazolidin-2-on)ethylmethacrylate, N-(methacrylamido)ethyl urea (SIPOMER WAM II, Rhone-Poulenc), and allyl ureido wet adhesion monomer (SIPOMER WAM, Rhone-Poulenc), among others.

The total acrylic polymer can be present in the coating composition, including both acrylic polymer binder and the acrylic portion of the AMF polymer, in an amount of from about 12 to about 75 wt %, based on the total weight of the acrylic polymer binder and the AMF polymer. The fluoropolymer (not including the acrylic polymer portion of the AMF polymer) is present in an amount of from about 8 to about 25 wt %, preferably from about 50 to about 90 wt %, based on the total weight of the acrylic polymer binder and the AMF polymer.

Colored pigments are finely ground natural or synthetic, insoluble particles used to impart color when added to paints and coatings compositions. Pigment refers to a class of organic or inorganic matter that is insoluble in water, not soluble in the use of media, but has been highly dispersed so that the colored matter is colored. Pigments used for coating are well known in the art. Non limiting examples of pigments include anatine, brookite, cadmium yellow, cadmium red, cadmium green, orange cobalt, cobalt blue, cerulean blue, aureolin, cobalt yellow, copper pigments, azurite, Han purple, Han blue, Egyptian blue, malachite, Paris green, phthalocyanine blue BN, phthalocyanine green G, verdigris, viridian, iron oxide pigments, sanguine, caput mortuum, oxide red, red ochre, Venetian red, Prussian blue, clay earth pigments, yellow ochre, raw sienna, burnt sienna, raw umber, burnt umber, marine pigments (e.g., ultramarine, and ultramarine green shade), and zinc pigments (e.g., zinc white, and zinc ferrite).

Opacifying pigment reflect light and are used to make a coating opaque or less transparent. They prevent light transmission and provide ideal brightness and whiteness to the end product. The most commonly used is Titanium dioxide (TiO₂), Barium Sulphate, zinc oxide, calcium carbonate, talc, nepheline syenite and combinations thereof. The most common and preferred is TiO₂. Extenders can also be added to the formulation. Suitable examples of extenders include precipitated grades of calcium carbonate, directly mined calcium carbonates, clean grades of magnesium calcium carbonate (Dolomite), clean grades of calcined, pulverized clays (aluminosilicates), and clean purified grades of magnesium silicate.

Coalescing agent—The coalescing agent is an important component of water-based latex or emulsion coating compositions. As the coating dries after being applied to a substrate, the purpose of the coalescent agent in these compositions is to aid the discrete particles of polymer that are present in the latex to form into a continuous film. The coalescent agent also can contribute to a good performance balance of various coating properties.

Coalescing agents normally are required in coating compositions since it is desired that the coating composition has the lowest possible MFFT and the highest possible glass transition temperature. Coalescing solvents are organic solvents or plasticizers that effectively lower the MFFT of the polymer to meet the desired low MFFT on application, and then eventually diffuse out of the coating composition and evaporate under normal ambient conditions of temperature, humidity, and atmospheric pressure, leaving a high Tg film.

Coalescent works by softening the polymer particles, allowing them to fuse into a tough, continuous film. Common coalescents include ester alcohols, esters, and glycol ethers, esters, alcohols, amides, and polymers. Coalescing agents are particularly used in water based paints, such as latex paints, to help the water evaporate more quickly and to improve the paints adhesion to the surface on which it is being painted.

Typical for fluoropolymer binders in coating compositions a coalescing agent is needed and increases VOC. By lowering the amount of fluoropolymer, a lower amount of coalescing agent is needed. The combination of a fluoropolymer in the form of an AMF polymer provides for less coalescing agent yet retains properties such as chalking.

The MFFT is the lowest temperature at which a binder agent or composition form a continuous film. A MFFT can be measured on a gradient temperature instrument in accordance to ASTM D 2354-10 (2012). An example of a suitable gradient temperature instrument is the Rhopoint Minimum Film Forming Temperature Bar (MFFT) is a self-contained bench top instrument available from Paul Gardner, Inc. Generally, coating composition of the invention can be applied to a substrate at temperatures above the MFFT of the composition. For example, an improved coating composition having an MFFT of 5° C. can be applied to a substrate and dried at ambient temperatures at or above about 5° C. As can be appreciated, both the binder agent and the composition can have respective MFFT values. In certain embodiments, the polymer blends of the invention can exhibit an MFFT of about 25° C. or less in certain embodiments, an MFFT of about 15° C. or less in certain embodiments, an MFFT of about 5° C. or less in certain embodiments, or an MFFT of about 2° C. or less in certain embodiments.

For increased usability, the MFFT of a coating composition can be lowered in certain embodiments through inclusion of a suitable coalescing agent into the coating composition. Such coalescing agents can generally be selected from slow evaporating solvents having elevated boiling points between, for example, about 160° C. to about 240° C. Non-limiting examples of suitable coalescing agents can include dipropylene glycol methyl ether, dipropylene glycol methyl ether acetate, dipropylene glycol n-butyl ether, ethylene glycol n-butyl ether, Texanol® ester-alcohol (Eastman Chemical Co.), and dipropylene glycol dimethyl ether. In certain embodiments, the coalescing agent can be about 2% or less of the total weight of the coating composition (including water), about 1.7% or less or about 1.5% or less of the total weight of the coating composition. As can be appreciated however, the lowest necessary quantity of a coalescing agent necessary to reach a suitable MFFT may be desired to allow for faster drying times and to ensure that the VOC of the coating composition remains below any applicable limits.

Plasticizers can also be added to lower the MFFT. Plasticizers can generally be distinguished from coalescing agents, however, by exhibiting a higher boiling point such as a boiling point of about 250° C. or more.

The composition of the invention is used as a coating on an architectural substrate, including but are not limited to wood, metal, plastic, and composites. The composition of the invention can be used for architectural coatings.

### EXAMPLES

### General Clearcoat Composition:

Approximately 65-75 g of neutralized latex (as indicated in Table 1), (35 g of resin solids), were admixed with Texanol® ester-alcohol (coalescent, 5.2 g), BYK-346 (0.5 g) silicone surfactant and water (to obtain 40% volume solids) to obtain a clearcoat. The clearcoats were drawn down over Leneta Opacity charts with a 6 mil doctor blade to determine their dry film properties. ASTM D4062-11 Standard Test Method for Leveling of Paints by Draw-Down Method

Acrylic 1 (Acrylic polymer binder) is an acrylic latex with a minimum film formation temperature (MFFT) of less than 0° C. and a weight % solids of 55%. Acrylic 2 is an acrylic latex with a minimum film formation temperature (MFFT) of 15° C. and a weight % solids of 58%. Acrylic 1 and Acrylic 2 are Acrylic polymer binders.

TABLE 1

| | Run 1 - | | Run 3 - | |
|---|---|---|---|---|
| | Acrylic | | Acrylic | |
| | comparative | | comparative | |
| | example | Run 2 | example | Run 4 |
| Acrylic 1 | 63.9 | 45.5 | | |
| Acrylic 2 | | | 60.3 | 43.1 |
| AMF polymer: | | 22.7 | | 22.7 |
| 70% PVDF/30% | | | | |
| acrylic (44% | | | | |
| solids) | | | | |
| Texanol ® | 5.4 | 5.2 | 5.4 | 5.2 |
| ester-alcohol | | | | |
| BYK-346 | 0.5 | 0.5 | 0.5 | 0.5 |
| Water | 13.5 | 5.2 | 15.6 | 6.9 |
| Total (grams) | 83.3 | 79.1 | 81.8 | 78.4 |
| Total polymer | 35.1 | 35.0 | 35.0 | 35.0 |
| solids_(grams) | | | | |
| Weight % | 42% | 44% | 43% | 45% |
| polymer Solids | | | | |
| DPUR (ΔE*) | 46.0 | 17.7 | 11.4 | 3.6 |

### Accent Base Composition:

Accent Pigment Grind A—A pigment grind was prepared as follows: a metal beaker, agitated at low speed (500 rpm) with a Cowles blade from an air-powered motor, is charged with the following: water, dispersant (Coadis 123K), ammonium hydroxide, defoamer (TEGO® Foamex 810) surfactant (Strodex™ PKOVOC) and potassium tripolyphosphate (KTPP). To this solution is added titanium dioxide (TiO₂) and Minex® 7. Stirrer speed is increased (up to 3500 rpm) for 20 minutes until the grind reaches a Hegman of 7+. This preparation can be referred to as the mil base.

TABLE 2

| Accent Pigment Grind A | (g) |
|---|---|
| Water | 6.0 |
| Coadis 123K | 0.4 |
| Ammonium Hydroxide (28%) | 0.03 |
| TEGO ® Foamex 810 | 0.1 |
| Strodex ™ PK0VOC | 1.0 |
| KTPP | 0.1 |
| Minex ® 7 | 12.6 |
| Kronos ® 2310 TiO₂ | 3.1 |

To a separate mixing vessel, equipped with overhead agitation and a mixing paddle, AMF polymer dispersion (44% by weight solids) is charged, followed by addition of coalescent (Texanol® ester-alcohol), plasticizer (Eastman Optifilm™ enhancer 400), acrylic latex (available from Arkema Inc.) and water.

For the comparative examples without the addition of AMF polymer, coalescent, plasticizer and water are added to the acrylic latex. Pigment grind is added, followed by HEUR thickener (Coapur XS-71 diluted by 50% in water) and allowed to stir for minimum 10 minutes. Colorant, COLORTREND® 888 Universal Architectural Colorants, is added to achieve desired hiding, starting at 1 g colorant/50 g of paint base.

These compositions were drawn down over chromated aluminum panels with a 6 mil blade to determine their dry film properties. These panels were submitted to accelerated weathering using ASTM G154-16, Standard Practice for Operating Fluorescent Ultraviolet (UV) Lamp Apparatus for Exposure of Nonmetallic Materials. Panels were submitted to accelerated weathering method using QUV-B bulbs (313 nm wavelength bulbs) @0.67/m² irradiance for 8 hours at 60° C., followed by 4 hours in a dark condensate cycle at 50° C. for a total of 4000 hours.

A coatings composition comprised of an acrylic latex and an AMF polymer dispersion was made according to Table 3. To an AMF polymer dispersion, add coalescent, water, acrylic latex, prepared accent base pigment grind, followed by associative thickeners.

TABLE 3

| | Run 5 - | | Run 7 - | |
|---|---|---|---|---|
| Components | comparative | | comparative | |
| listed in grams | example | Run 6 | example | Run 8 |
| Accent Pigment | 23.4 | 21.2 | 21.2 | 19.4 |
| Grind A | | | | |
| Acrylic 1 | 58.5 | 41.9 | | |
| Acrylic 2 | | | 55.5 | 39.8 |
| AMF polymer: | | 20.8 | | 20.8 |
| 70% PVDF/30% | | | | |
| acrylic (44% | | | | |
| solids) | | | | |
| Texanol ® ester- | 1.75 | 1.75 | 1.75 | 1.75 |
| alcohol | | | | |
| Eastman | 0.9 | 0.9 | 0.9 | 0.9 |
| Optifilm ™ | | | | |
| enhancer 400 | | | | |
| Water | 15.2 | 7.8 | 17.5 | 9.3 |
| Coapur XS- | 0.6 | 0.6 | 0.6 | 0.6 |
| 71(50% in | | | | |
| water) | | | | |
| Total polymer | 32.2 | 32.2 | 32.2 | 32.2 |
| solids (grams) | | | | |
| % PVDF (based | 0 | 20 | 0 | 20 |
| on polymer | | | | |
| solids) | | | | |
| Weight % Solids | 49.4 | 50.5 | 49.7 | 49.3 |
| wt % Coalescent | 5% | 5% | 5% | 5% |
| on wt % polymer | | | | |
| solids | | | | |
| Pigment Volume | 16.1 | 15.9 | 16.4 | 15.1 |
| Concentration | | | | |
| (%) | | | | |
| Delta E* Color | 16.2 | 8.5 | 11.4 | 7.2 |
| Change After | | | | |
| 4000 hours QUV- | | | | |
| B | | | | |

The lower the Delta E* value indicates better color retention. The values in Table 3 show that improved color retention is achieve with less than 20% fluoropolymer.

TABLE 4

| | Chalking Rating (on | |
|---|---|---|
| Panel # | Black) | % PVDF |
| Run 5 + blue | 4 | 0 |
| Run 6 + blue | 8 | 20 |
| Run 7 + blue | 4 | 0 |
| Run 8 + blue | 8 | 20 |

Table 4: Runs 5 through 8 (from Table 3) were tested. The results are in Table 4. This series are accent base formulations tinted with phthalo blue colorant with either 0 or 20% fluoropolymer content based on polymer solids. Table 4 shows that at PVDF levels at 20%, chalking results improve after submitting panels to 4000 hours QUV-B weathering.

### Chalking:

For Chalking Results, no improvement seen below 4% PVDF content.

Chalking Test performed using ASTM D4214-07 Standard Test Method for Evaluating the Degree of Chalking of Exterior Paint Films, Method C—transparent tape method. ASTM ranking is from 0-8 with 0 being the worst (completely opaque) and 8 being the best (clear; no evidence of chalking).

TABLE 5
Chalking results of panels

| Panel Color | Results | % Fluoropolymer |
|---|---|---|
| Accent Base - red | 0 | 0 |
| Accent Base - red | 0 | 3 |
| Accent Base - red | 0 | 6 |
| Accent Base - green | 4 | 0 |
| Accent Base - green | 4 | 3 |
| Accent Base - green | 4 | 6 |
| Accent Base - purple | 4 | 0 |
| Accent Base - purple | 4 | 3 |
| Accent Base - purple | 4 | 6 |

Table 5—This series are accent base compositions with less than 6% PVDF on polymer solids. This chart shows that at fluoropolymer levels at 6 wt % and below, there is no change in chalking after 4000 hours QUV-B weathering.

TABLE 6
Chalking results of panels

| | | % PVDF |
|---|---|---|
| Panel color | Results | present |
| White Base | 7 | 25 |
| White Base | 6 | 12.5 |
| White Base | 2 | 2.5 |
| Accent Base - red | 8 | 25 |
| Accent Base - red | 4 | 12.5 |
| Accent Base - red | 2 | 2.5 |

Table 6: This series are accent base formulas without pigment and with red colorant at various levels of fluoropolymer content. Coated substrates are exposed to 4000 hours of QUV-B weathering (method is listed above). Chalking was performed using ASTM D4214-07 Standard Test Method for Evaluating the Degree of Chalking of Exterior Paint Films, Method C—transparent tape method. ASTM ranking is from 0-8 with 0 being the worst (completely opaque) and 8 being the best (clear; no evidence of chalking).

This chart shows that chalking ratings are improved with increasing PVDF levels (in the form of an AMF polymer). This shows that the addition of AMF polymer improves in chalking.

### Dirt Pick-Up Resistance:

For Dirt Pickup Resistance, benefits are observed with addition of PVDF content in the form of AMF polymer.

Dirt Pickup Resistance is measured testing using an aqueous slurry comprised of hydrophobic carbon black (Birla Raven 22) and BYK 346 as a wetting agent. The slurry is applied onto the dried coating at room temperature for 4 hours, and then gently rinsed away with cold water and a paper towel. The dirt pickup resistance is then measured using a colorimeter, as the difference in color Delta E* before and after the test. (as measured according to 1976 CIE L*a*b*). ΔE* measurements on made after the film has dried, comparing the soiled versus unsoiled parts of the coating. Lower ΔE* indicate better Dirt Pickup Resistance (“DPUR”)

TABLE 7
DPUR - ΔE* values for various compositions

| | Run 1 | Run 2 | Run 3 | Run 4 |
|---|---|---|---|---|
| % Acrylic 1 polymer solids | 100% | 80% | | |
| % Acrylic 2 polymer solids | | | 100% | 80% |
| % Fluoropolymer polymer solids | | 20% | | 20% |
| DPUR ΔE* | 46 | 17.7 | 11.4 | 3.6 |

Table 7: Runs 1-4 of Table 1 were tested for Dirt Pickup Resistance. This chart shows that the PVDF improves in DPUR regardless of MFFTs acrylics.

### Color Retention:

For color retention, see improvement (dependent on pigment) as low as 3.5% PVDF. PVDF is in the form of an AMF polymer.

TABLE 8

| | | Acrylic 1 + | Acrylic 1 + |
|---|---|---|---|
| | Acrylic 1 | 3.3% PVDF | 6.8% PVDF |
| Hours | 0% PVDF | present | present |
| 0 | 0 | 0 | 0 |
| 500 | 8.5 | 8.1 | 7.2 |
| 1000 | 9 | 9 | 8 |
| 1500 | 11 | 9 | 9 |
| 2000 | 15 | 12 | 11 |
| 2500 | 17 | 15 | 13 |
| 3000 | 20 | 18 | 16 |
| 3500 | 23 | 21 | 18 |
| 4000 | 35 | 26 | 21 |

Table 8: This table shows the Color Retention (Delta E*) every 500 hours for a total of 4000 hours QUV-B weathering. The three different coatings were formulated with Acrylic 1 and with 0, 3.3 or 6.80 fluoropolymer from an AMF polymer dispersion and tinted with phthalo blue colorant. Lower ΔE* values indicates better color retention.

A coating prepared by only physically blending fluoropolymer seed with acrylic latex in the letdown section will result in poor film formation, exhibited by worse dirt pickup resistance.

TABLE 9

| | | Comparative Example without |
|---|---|---|
| | Wt % of composition | AMF polymer |
| Acrylic 2 | 27.1 | 24.3 |
| Fluoropolymer Seed | | 8.4 |
| AMF polymer: 70% | 11.5 | |
| PVDF/30% acrylic (44% | | |
| solids) | | |
| BYK-346 | 0.1 | 0.1 |
| Coalescent | 0.7 | 0.7 |
| HEUR Thickening Agent | 0.4 | 0.4 |
| (50% in water) | | |
| Water | 5.8 | 6.6 |
| Polymer solids | 17.6 | 17.6 |
| wt % PVDF on polymer solids | 20% | 20% |
| wt % coalescent on polymer | 2% | 2% |
| solids | | |
| Wt % solids | 43% | 43% |
| DPUR (ΔE*) | 6.2 | 12.0 |

Table 9 shows that a mechanical blend of a fluoropolymer and an acrylic polymer binder does not provide the same benefit that the blend of an AMF polymer and an acrylic polymer binder provides.

1. An aqueous coating composition comprising:
a. from 8-25% PVDF polymer based on total weight of polymer (acrylic polymer binder plus AMF polymer) in the composition,
b. acrylic polymer (includes both the acrylic polymer binder and the acrylic polymer portion of the AMF polymer,
c. an opacifying pigment,
d. water,
e. and less than 3.9 wt % amount of coalescing agent based on total wet composition,
wherein the PVDF is in the form of an AMF polymer.

2. The aqueous coating composition of claim 1, wherein the PVDF in the composition is from 10 to 25 wt % based on total polymer in the composition.

3. The aqueous coating composition of claim 1, wherein the PVDF in the composition is from 10 to 20 wt % based on total polymer in the composition.

4. The aqueous coating composition of claim 1, wherein the AMF polymer comprises from 30 wt % to 70 wt % PVDF and from 70 wt % to 30 wt % acrylic polymer portion.

5. The aqueous coating composition of claim 1, wherein the AMF polymer comprises from 40 wt % to 85 wt % PVDF and from 60 wt % to 15 wt % acrylic polymer portion based on total wt of AMF polymer.

6. The aqueous coating composition of claim 1, wherein the acrylic polymer portion of the AMF polymer comprises (methyl) methacrylate monomer units.

7. The aqueous coating composition of claim 1, wherein the total acrylic polymer (acrylic polymer binder plus the acrylic portion of the AMF polymer) in the composition is from 75 to 92 wt % based on total polymer in the composition.

8. The aqueous coating composition of claim 1, further comprising at least one colored pigment.

9. The aqueous coating composition of claim 1, wherein the coalescing agent is less 3 wt % based on total wet composition.

10. The aqueous coating composition of claim 1, wherein the coalescing agent is less 2.5 wt % based on total wet composition, preferably less than 2% or less of the total weight of the coating composition (including water).

11. The aqueous coating composition of claim 1, wherein the coalescing agent is less 1.7 wt % based on total wet composition.

12. A method of coating a substrate comprising provide a substrate, providing the coating composition of claim 1, applying the coating composition to the substrate, drying the coating composition on the substrate to form a coating.

13. A coating comprising any one of the coating compositions of claim 1, wherein the coating exhibits an improved chalking (ASTM 4214-07) compared to the same coating composition without the AMF polymer.

14. The coating of claim 13, wherein the chalking value of at least 4 is obtained.

15. The coated of claim 13, and wherein the coating exhibits an improved dirt pickup resistance over a coating that does not contain the AMF polymer.

16. The coated of claim 13, and wherein the colored pigment after 4000 hours of QUV-B weathering, has improved color retention over a coating that does not contain the AMF polymer.

17. The coated of claim 16, where in the improvement of color retention is at least 10% less, as measure by change in Delta E* over 4000 hours QUV-B weathering then the same coating made except without the AMF polymer (substituting the acrylic polymer binder in the formulation tested for the AMF polymer).
